(19) United States
(12) Patent Application Publication
(10) Pub. No.: US 2004/0255746 A1
(43) Pub. Date: Dec. 23, 2004

(54) Shearing device for peripheral wall of tube

(75) Inventors: Hitoshi Ishida, Shizuoka-ken (JP); Masuo Kawachi, Toyohashi-shi (JP)

Correspondence Address: LORUSSO, LOUD & KELLY, 3137 Mt. Vernon Avenue, Alexandria, VA, 22305, US

(73) Assignees: CREATECH CO., LTD.; MUSASHI SEIMITSU KOGYO KABUSHIKI KAISHA

(21) Appl. No.: 10/868,884

(22) Filed: Jun. 17, 2004

(30) Foreign Application Priority Data
Jun. 20, 2003 (JP) 2003-175772

(51) Int. Cl. B23D 21/14

(52) U.S. Cl. 83/178

(57) ABSTRACT

A shearing device including a retainer having a mountain-shaped inclined surface on its top and fixed in a standing posture, a plurality of side punches each having an operating surface on one side thereof. The side punches are arranged in a radial pattern with the respective operating surfaces directed outward and are placed in a standing posture on the inclined surface so as to be slidable. A cylindrical die is disposed to surround the side punches and has in its peripheral wall punch apertures facing the respective operating surfaces of the side punches. An actuator is provided for pushing the side punches and the die to simultaneously move downward.

### CROSS-REFERENCE TO RELATED APPLICATION

This application claims, under 35 USC 119, priorities of Japanese Patent Application No. 2003-175772, filed Jun. 20, 2003, disclosures of which, inclusive of the specification, claims and drawings, are hereby incorporated by reference herein.

### BACKGROUND OF THE INVENTION

1. Field of the Invention:

The present invention relates to a shearing device for cutting a cylindrical side wall of a workpiece to form a product having a plurality of leg portions, such as a carrier case for planetary gears.

2. Description of Prior Art

Conventionally, to produce a product having a plurality of leg portions extending from an outer peripheral portion of annular plate, such as carrier case for planetary gears, the leg portions have been welded at predetermined intervals along the outer periphery of the annular plate.

The above conventional technique, however, requires much man-hours and high production costs, because a large number of parts are required. Yet, the product has poor accuracy due to thermal deformation during the welding.

### SUMMARY OF THE INVENTION

It is an object of the present invention to provide a shearing device which can produce a product having a plurality of leg portions on an annular or circular plate with high speed and high accuracy.

In accomplishing the above object, the present invention provides a shearing device for cutting a workpiece having a cylindrical side wall, comprising:

a base;

a retainer fixedly secured on said base and having an upper surface provided with a plurality of radially downwardly inclined faces;

a plurality of side punches corresponding in number to the number of said inclined faces and slidably placed on respective inclined faces, each of said side punches being radially displaceable along the corresponding inclined face between an upper position and a lower position and having a radially outwardly facing operating surface;

a cylindrical die supported on said base to surround said side punches and vertically moveable between an upper position and a lower position,

said cylindrical die having a plurality of die apertures corresponding in number to the number of said side punches and facing the corresponding operating surfaces of said side punches such that a gap in which said cylindrical side wall of said workpiece is positionable is defined therebetween when said side punches and said cylindrical die are located at their upper positions and that said operating surfaces enter said punch apertures when said side punches and said cylindrical die are located at their lower positions; and

an actuator for simultaneously displacing said side punches and said cylindrical die from their upper positions to their lower positions.

### BRIEF DESCRIPTION OF THE DRAWINGS

Other objects, features and advantages of the present invention will become apparent from the detailed description of the preferred embodiments of the invention which follows, when considered in light of the accompanying drawings, in which:

FIG. 1 is a cross-sectional elevational view of an embodiment of a shearing device according to the present invention, in which the left hand half shows a state of the shearing device before shearing and the right hand half shows a state after shearing; and

FIG. 2 is a plan view, partly in cross-section and cut away in part, of the shearing device of FIG. 1, in which both states before and after shearing are shown.

### DESCRIPTION OF THE PREFERRED EMBODIMENT

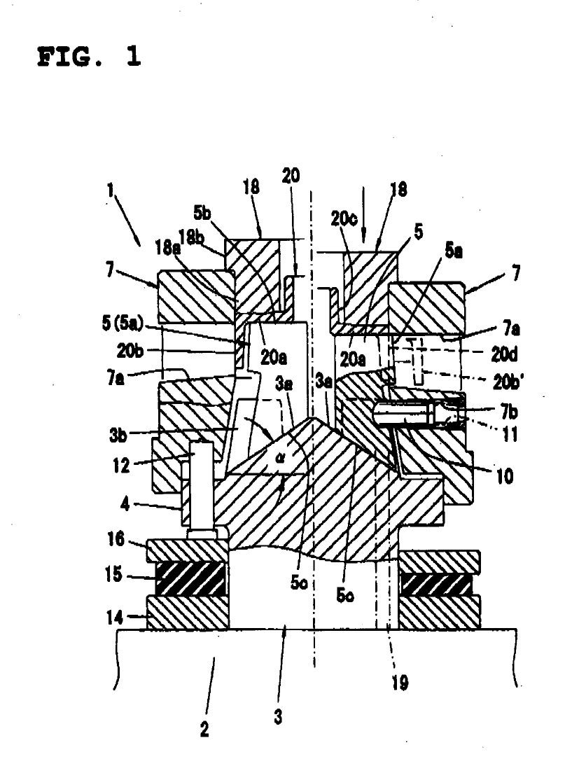

Referring to FIG. 1, the reference numeral 1 denotes a shearing device, 2 a base of the shearing device 1, and 3 a retainer fixed to the base 2 in a standing posture.

The retainer 3 has a mountain-shaped inclined surface 3a on its top and four guide ribs 3b protruding upward and arranged at regular intervals circumferentially on the outer peripheral portion of the inclined surface 3a.

In the illustrated embodiment, the inclined surface 3a is constituted as four inclined faces of a quadrangular pyramid, with each of the inclined faces forming an angle a of 55 degrees with respect to the horizontal plane. The angle a may vary and may be determined as appropriate depending on the size, thickness and/or material of a work 20.

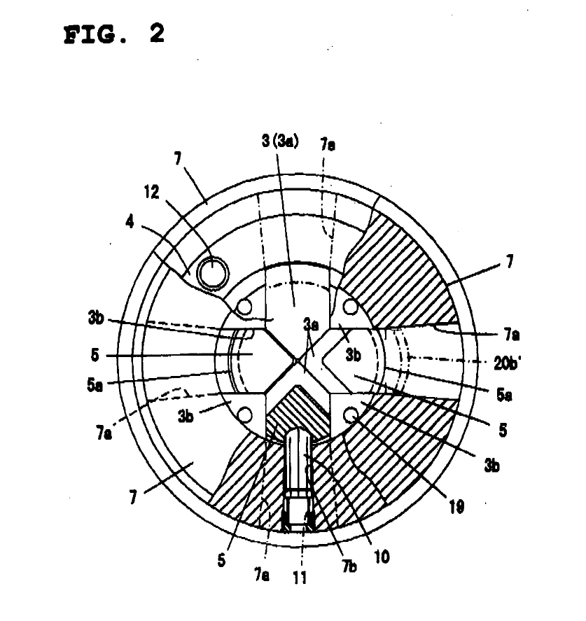

As shown in FIG. 2, the guide ribs 3b have guide surfaces arranged such that adjacent two guide surfaces are in parallel with each other. Thus, four guide grooves (of which reference numerals are not shown) extending in radial directions are defined on the outer peripheral portion of the inclined surface 3a.

A side punch 5 is fitted in a space (guide groove) between each of the adjacent two ribs 3b of the retainer 3 so as to be slidable in a radial direction between an upper, non-operating position as shown in the left hand half in FIG. 1 and a lower, operating position as shown in the right hand half in FIG. 1. Namely, each of the side punches 5 has a flat lower surface 5c which is in face to face contact with the corresponding inclined face of the inclined surface 3a and is slidable thereon. Each side punch 5 has an operating surface 5a protruding radially outward in its upper portion and a horizontally extending smooth upper surface 5b.

A flange 4 with a large diameter is formed on an upper portion of the retainer 3. A cylindrical die 7 is fitted around the outer peripheral portion of the flange 4 so as to be slidable vertically between an upper position as shown in the left hand half in FIG. 1 and a lower position as shown in the right hand half in FIG. 1. The cylindrical die 7 is disposed to surround the side punches 5 with a predetermined gap, in which a cylindrical side wall of a workpiece 20 is positionable, when the side punch 5 and the die 7 are located at their upper positions as shown in the left hand half in FIG. 1.

The die 7 has punch apertures 7a extending radially in its peripheral wall at positions facing the operating surfaces 5a of the side punches 5.

The die 7 also has pin holes 7b formed radially in its lower portion at positions facing lower portions of the side punches 5. A guide pin 10 is fitted slidably in each pin hole 7b. The guide pin 10 has one end portion engaging with a recess formed in the lower portion of the side punch 5. Each guide pin 10 is pushed inward by a compression spring (side pusher) 11 provided at the outer end of the pin hole 7b, so that the side punch 5 is normally urged to move toward the axial center of the retainer 3.

Four support pins 12 are fixed to a lower portion of the die 7 to protrude downward. The support pins 12 are arranged at regular intervals circumferentially, with their lower portions passing through the flange 4 of the retainer 3 so as to be slidable vertically. A fixed plate 14, an elastic member 15 and a movable plate 16, of a washer shape, are fitted around the outer peripheral portion of the lower portion of the retainer 3, stacked in this order from the lowest upward, The fixed plate 14 is placed on the base 2. The lower ends of the support pins 12 abut on the movable plate 16, so that the die 7 is held at such a predetermined height that each punch aperture 7a faces the operating surface 5a of the corresponding side punch 5.

As shown in FIG. 1, the workpiece 20 is fitted between the side punches 5 and the die 7. The work 20 in this embodiment is formed in a stepped tube, having an annular portion 20a, and a large tubular portion 20b and a small tubular portion 20c formed integrally with the lower and upper sides of the annular portion 20a, respectively. The annular portion 20a is placed on top of the side punches 5 with the large tubular portion 20b fitted in the gaps between the side punches 5 and the die 7. The workpiece 20 is a unitary member formed by forging and with a lathe in advance.

An upper punch (actuator) 18 is provided above the side punches 5 and the die 7. The upper punch 18 is formed in a stepped shape, having a small inner punch portion 18a and a large outer punch portion 18b in its lower and upper portions, respectively. As shown in FIG. 1, the inner punch portion 18a is fitted with the upper portion of the die 7, to strike the disk portion 20a of the work 20 at the same time as the outer punch portion 18b strikes the upper edge of the die 7. In FIG. 1, reference numeral 19 denotes an ejector pin engageable with remaining legs of a processed product for removing the product from the side punches 5 and the die 7,

The shearing device constituted as above operates as follows. The large tubular portion (cylindrical side wall) 20b of the workpiece 20 is fitted in the gaps between the side punches 5 and the die 7 located in their upper positions as shown in the left hand half in FIG. 1, while the annular portion 20a is placed on top of the side punches 5. When the upper punch 18 is lowered in this state, the inner punch portion 18a pushes down the side punches 5 together with the workpiece 20 through the annular portion 20a of the workpiece 20, and at the same time the outer punch portion 18b pushes down the die 7 against the biasing force of the elastic member 15.

Since the side punches 5 are placed on the inclined surface 3a of the retainer 3 and abut on the lower surface of the annular portion 20a of the workpiece 20, the side punches 5 gradually move laterally outward along the inclined surface 3a and the lower surface of the annular portion 20a of the workpiece 20 as the side punches 5 are moved downward by the inner punch portion 18a. Finally, the operating surfaces 5a of the side punches 5 are fitted into the respective punch apertures 7a of the die 7, as shown in the right hand half in FIG. 1, so that four portions 20b of the tubular portion 20b are sheared and removed to leave four legs 20d.

In this case, since the workpiece 20 is surrounded (backed up) by the die 7, except the positions where the tubular portion 20b faces the punch apertures 7a, and since the annular portion 20a is tightly pressed between the upper punch 18 and the side punches 5, the tubular portion 20b can be sheared accurately by the side punches 5.

In this manner, openings or window holes are formed in the tubular portion 20b at four positions circumferentially, thereby obtaining a product having four leg portions 20d on the outer periphery of the annular portion 20a, such as carrier case for planetary gears.

When the upper punch is 18 retracted upward, the side punches 5 move toward the axial center by the action of the spring 11, allowing easy removal of the product by the ejector pins 19 and easy mounting of a new workpiece.

Various modifications may be made to the above embodiment. For example, to change the number of the leg portions 20d, the number of the side punches 5, the number of the inclined faces of the inclined surface 3a and the punch apertures 7a may be changed accordingly. The inclined surface 3a may have any desired shape as long as the side punches can radially slide thereon. The elastic member 15 may be replaced by any biasing member such as springs as long as the cylindrical die is urged toward the upper position.

As is clear from the above description, in the present invention, a plurality of side punches each having a radially outwardly facing operating surface are arranged in a radial pattern on an inclined surface of a mountain-shaped retainer. The side punches are surrounded by a cylindrical die having in its peripheral wall punch apertures facing the respective operating surfaces. As an upper punch pushes the side punches and the die to move downward, the side punches move outward along the inclined surface of the retainer. Thus, there can be formed a product having a plurality of leg portions on the outer periphery of a disk body, such as carrier case for planetary gears, with high speed and accuracy. In addition, since the inclined surface of the retainer is provided with ribs for guiding the side punches in the radial direction, the side punches move stably in the radial direction, stabilizing the processing accuracy (accuracy in forming a hole in a work).

While a detailed description of a preferred embodiment of the present invention has been disclosed above, it will be apparent to those skilled in the art that various alternatives, modifications and equivalents may fall within the scope of the present invention. Therefore, the above description should not be taken as limiting the scope of the present invention which is defined by the appended claims.

What is claimed is:

1. A shearing device for cutting a workpiece having a cylindrical side wall, comprising:
a base;
a retainer fixedly secured on said base and having an upper surface provided with a plurality of radially downwardly inclined faces;
a plurality of side punches corresponding in number to the number of said inclined faces and slidably placed on respective inclined faces, each of said side punches being radially displaceable along the corresponding inclined face between an upper position and a lower position and having a radially outwardly facing operating surface;
a cylindrical die supported on said base to surround said side punches and vertically moveable between an upper position and a lower position,
said cylindrical die having a plurality of die apertures corresponding in number to the number of said side punches and facing the corresponding operating surfaces of said side punches such that a gap in which said cylindrical side wall of said workpiece is positionable is defined therebetween when said side punches and said cylindrical die are located at their upper positions and that said operating surfaces enter said punch apertures when said side punches and said cylindrical die are located at their lower positions; and
an actuator for simultaneously displacing said side punches and said cylindrical die from their upper positions to their lower positions.

2. A shearing device as claimed in claim 1, further comprising side pushers mounted in said cylindrical die for pushing said side punches radially inward so that each of said side punches is normally urged radially inward.

3. A shearing device as claimed in claim 1, further comprising a biasing member connected to said cylindrical die for normally urging said cylindrical die toward said upper position.

4. A shearing device as claimed in claim 1, wherein each of said inclined faces of said retainer is flat surface and wherein ribs are provided on said flat surfaces for guiding the side punches in the radial direction.
